(19) United States
(12) Patent Application Publication
(10) Pub. No.: US 2017/0162342 A1
(43) Pub. Date: Jun. 8, 2017

(54) COMPOSITION FOR COATING OF ELECTRICAL CONTACT POINT AND METHOD FOR COATING OF ELECTRICAL CONTACT POINT USING THE SAME COMPOSITION

(71) Applicant: HYUNDAI MOTOR COMPANY, Seoul (KR)

(72) Inventor: Na Yun KO, Seoul (KR)

(21) Appl. No.: 15/360,334

(22) Filed: Nov. 23, 2016

(30) Foreign Application Priority Data
Dec. 8, 2015 (KR) 10-2015-0174038

(51) Int. Cl. H01H 1/021; C09D 127/18; H01H 11/04; C09D 5/24

(52) U.S. Cl. CPC H01H 1/021; C09D 5/24; C09D 127/18; H01H 11/048

(57) ABSTRACT

A composition for coating an electrical contact point includes a silver powder and a fluorinated resin. The silver powder is dispersed in the fluorinated resin, and a weight ratio of the silver powder for the fluorinated resin is in a range from 0.4 to 1.

### CROSS-REFERENCE TO RELATED APPLICATION

This application claims the benefit of priority to Korean Patent Application No. 10-2015-0174038 filed in the Korean Intellectual Property Office on Dec. 8, 2015, the entire content of which is e incorporated herein by reference.

### TECHNICAL FIELD

The present disclosure relates to a composition for coating an electrical contact point and a method for coating the electrical contact point using the same.

### BACKGROUND

In general, an electrical contact point is a part used for opening and closing of a circuit current, such as a switch or a relay, and for opening and closing a contact part of a current path. Here, to maintain a well-conductive state, a copper alloy is generally plated with silver or gold as a contact point material, in which the plating improves an abrasion resistance of the contact point.

Accordingly, to obtain high durability and reliability of such a contact point, a plating technique using the copper alloy as the contact point material has been used. Here, silver plating has been generally applied, and nickel underlying plating can be further performed.

However, when a plating thickness increases, a plating process takes an undesirably long period of time due to the plating process characteristics. In addition, when nickel underlying plating is applied, an electric characteristic deterioration may be generated due to the thickness of the material.

Further, in order to reduce a friction coefficient of a switch contact point, a grease must be applied on the contact point. Here, a contact resistance may increase due to a friction coefficient and an excessive abrasion depending on a grease viscosity, the environment, a location, etc.

In addition, a technique of mixing and sintering a silver powder and a carbonaceous solution to manufacture an electrical contact point may be used, however, this technique requires an additional process of removing a solvent through heating in a high temperature. In such a technique of mixing and sintering, the mechanical properties are deteriorated compared with the general plating process.

The above information disclosed in this Background section is only for enhancement of understanding of the background of the invention, and therefore, it may contain information that does not form the prior art that is already known in this country to a person of ordinary skill in the art.

### SUMMARY

The present disclosure provides a composition for coating an electrical contact point and a coating method of the electrical contact point using the same.

According to an exemplary embodiment of the present disclosure, a composition for coating an electrical contact point includes a silver powder and a fluorinated resin. The silver powder may be dispersed in the fluorinated resin, and a weight ratio of the silver powder for the fluorinated resin may be in a range from 0.4 to 1.

A diameter of the silver powder may be in a range from 3 to 50 μm.

The fluorinated resin may include polytetrafluoroethylene (PTFE), tetrafluoroethylene-perfluoroalkyl vinyl ether copolymer (PFA), tetrafluoroethylene hexafluoropropylene copolymer (FEP), ethylene tetrafluoroethylene (ETFE), polychlorotrifluoroethylene (PCTFE), ethylene chlorotrifluoroethylene (ECTFE), polyvinylidene fluoride (PVDF), polyvinyl fluoride (PVF), or combinations thereof.

According to another exemplary embodiment in the present disclosure, a method for coating an electrical contact point includes steps of: preparing a contact point base material; preparing a composition for coating an electrical contact point; coating the composition for coating the electrical contact point on the contact point base material; and hardening the coated composition to form a coating layer on a surface of the contact point base material.

In the step of preparing the composition for coating the electrical contact point, the composition for coating the electrical contact point may include a silver powder and a fluorinated resin, the silver powder may be dispersed in the fluorinated resin, and a weight ratio of the silver powder for the fluorinated resin may be in a range from 0.4 to 1.

A diameter of the silver powder may be in a range from 3 to 50 μm.

The fluorinated resin may include PTFE, PFA, FEP, ETFE, PCTFE, ECTFE, PVDF, PVF, or combinations thereof.

In the step of preparing the contact point base material, the contact point base material may be a copper or a copper alloy.

In the step of coating the composition for coating the contact point on the contact point base material, a roll coating method, a spray method, or a dipping method may be performed.

The step of forming the coating layer on the surface of the contact point base material by hardening the coated composition may be performed in a temperature range from 150 to 250° C. for 10 to 60 minutes. A thickness of the coating layer may be in a range from 3 to 100 μm.

According to the exemplary embodiment of the present disclosure, the coating layer may be formed on the contact point base material surface by using the composition in which the silver powder and the fluorinated resin are mixed. Accordingly, the friction coefficient of the electrical contact point may be reduced and the abrasion resistance may be improved. Further, the lubrication characteristic may be provided without the grease and an usage amount of the silver powder may be reduced.

### BRIEF DESCRIPTION OF THE DRAWINGS

FIGS. 1A and 1B are graphs comparing a sheet resistance value of an exemplary embodiment of the present disclosure and a comparative example.

### DETAILED DESCRIPTION

The advantages and features of the present disclosure and a method of achieving them will be made clear by referring to the exemplary embodiments described below in detail with reference to the accompanying drawings. However, the present disclosure is not limited to the exemplary embodiments described below and may be implemented in various ways, the exemplary embodiments are provided to complete the present disclosure and make the scope of the present disclosure clear to those skilled in the art, and the present disclosure is defined only by the range described in claims. Like reference numerals indicate like constituent elements throughout the specification.

Therefore, well-known technologies will not be described in detail in some exemplary embodiments in order to avoid unclear description of the present disclosure. Unless otherwise defined, all of terminologies (including technical and scientific terminologies) used herein may be used with meanings that those skilled in the art understand. Throughout the specification, unless explicitly described to the contrary, the word “comprise” and variations such as “comprises” or “comprising” will be understood to imply the inclusion of stated elements but not the exclusion of any other elements. Further, singular terms include plural terms, unless specifically stated otherwise.

A composition for coating an electrical contact point coating according to an exemplary embodiment of the present disclosure includes a silver powder and a fluorinated resin. Here, the silver powder is dispersed in the fluorinated resin, and a weight ratio of the silver powder for the fluorinated resin may be in a range of 0.4 to 1.

In detail, when coating the electrical contact point by using the composition including the silver powder and the fluorinated resin, a friction coefficient may be reduced and the abrasion resistance may be improved. A similar effect to the silver plating layer may be obtained.

When the weight ratio of the silver powder for the fluorinated resin exceeds 1, the dispersion of the power may be difficult in the fluorinated resin due to the excess silver powder, thereby the sheet resistance value may be different depending on positions of the electrical contact point.

In contrast, when the weight ratio of the silver powder for the fluorinated resin is less than 0.4, a distance between the silver powders in the fluorinated resin may be far from each other, thereby the sheet resistance value is increased such that an operation defect may be generated.

The diameter of the silver powder may be in a range of 3 to 50 μm.

The diameter of the silver powder may be limited by considering a sheet resistance value, when the diameter thereof is very small or large, the sheet resistance value may be increased.

The fluorinated resin may include polytetrafluoroethylene (PTFE), tetrafluoroethylene-perfluoroalkyl vinyl ether copolymer (PFA), tetrafluoroethylene hexafluoropropylene copolymer (FEP), ethylene tetrafluoroethylene (ETFE), polychlorotrifluoroethylene (PCTFE), ethylene chlorotrifluoroethylene (ECTFE), polyvinylidene fluoride (PVDF), polyvinyl fluoride (PVF), or combinations thereof, however it is not limited thereto.

A coating method of an electrical contact point according to another exemplary embodiment of the present disclosure may include: preparing a contact point base material; preparing a composition for coating the electrical contact point; coating the composition for coating the electrical contact point on the contact point base material; and hardening the coated composition to form a coating layer on the contact point base material surface.

In the step of preparing the contact point base material, the contact point base material may be a copper or a copper alloy.

In the step of preparing the composition for coating the electrical contact point, the composition for coating the electrical contact point includes a silver powder and a fluorinated resin. Here, the silver powder is dispersed in the fluorinated resin, and the weight ratio of the silver powder for the fluorinated resin may be from 0.4 to 1.

The composition for coating the electrical contact point is the same as the above-described composition such that the overlapped description is omitted.

In the step of coating the composition for the contact point coating on the contact point base material, a roll coating method, a spray method, or a dipping method may be performed. However, it is not limited thereto.

Next, the step of hardening the coated composition may be performed in a temperature range from 150 to 250° C. for 10 to 60 minutes. In additional, a thickness of the coating layer formed through the above step may be in the range from 3 to 100 μm.

In detail, the hardening temperature may be changed depending on the used fluorinated resin. Further, when the hardening is appropriately performed by the above temperature and time range, a close contacting property of the coating layer for the contact point base material may be improved. However, when the ranges are not satisfied, the coating layer may be peeled off by the abrasion phenomenon, thereby the role as the contact point may be not acted for the coating layer.

Next, the present disclosure will be described in detail through an exemplary embodiment. However, the following description only illustrates exemplary embodiments, and the contents of the present disclosure are not limited by the following exemplary embodiment.

### An Exemplary Embodiment

First, a copper as a contact point base material is prepared.

Next, the silver powder having a diameter of 9 μm is dispersed in DAIKIN, TC-9109-04 of the fluorinated resin including polytetrafluoroethylene (PTFE) to prepare the composition for the electrical contact point coating. In this case, the weight ratio of the silver powder for the fluorinated resin is 0.7.

Next, the composition for the contact point coating is coated on the copper base material through the dipping method.

The coated composition is hardened for 30 minutes in 180° C. to form the coating layer on the surface of the copper base material, and the thickness of the coating layer is 50 μm.

### Comparative Example

An electrical contact point in which silver is plated to a copper base material is prepared.

### Experimental Example; Comparison Experiment of a Sheet Resistance Value of an Exemplary Embodiment and a Comparative Example

The sheet resistance values of the exemplary embodiment and the comparative example are respectively measured by performing a switch reciprocal motion for several times under a condition without applying grease. Here, the sheet resistance is measured under the condition of a two-wire method and the room temperature.

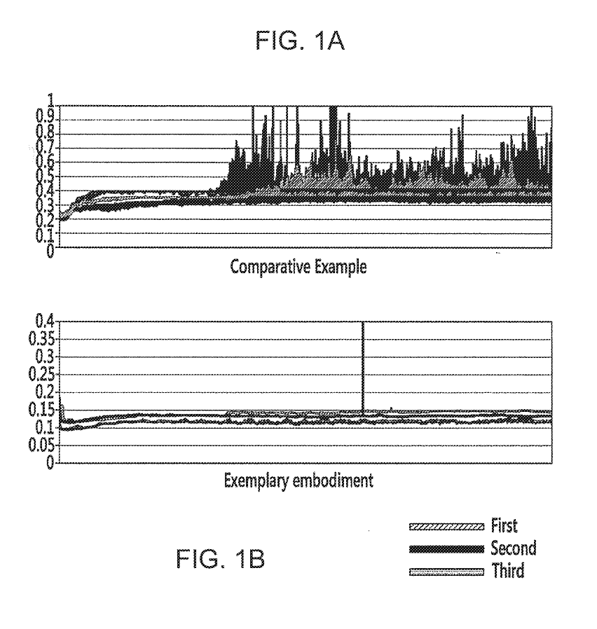

A result thereof is shown in FIGS. 1A and 1B which is the graph comparing the sheet resistance values of the exemplary embodiment and the comparative example.

In detail, as shown in FIGS. 1A and 1B, it is confirmed that sheet resistance value appears to be higher in the comparative example than the exemplary embodiment of the present invention. In the exemplary embodiment, the sheet resistance value appears to be lower, and thereby, the abrasion resistance may be improved compared with the comparative example in which the silver is plated. In addition, the friction coefficient may be reduced, and the lubrication characteristic may be provided under the condition without the grease.

Furthermore, as the coating technique, the silver powder and the fluorinated resin according to the exemplary embodiment of the present disclosure may be applied to various base materials, and the mechanical properties of the electrical contact point may be obtained for the purposes.

Although the exemplary embodiments of the present disclosure have been described with reference to the accompanying drawings, it will be apparent to those skilled in the art that various modifications and changes may be made thereto without departing from the technical spirit or essential feature of the invention.

Therefore, it is understood that the above exemplary embodiments are illustrative only but are not limitative. The scope of the present disclosure is represented by the claims as described later rather than the detailed description, and it is to be construed that all modifications and modified embodiments deduced from the meaning and the scope of the claims, and the equivalent concept thereto are included within the scope of the present disclosure.

What is claimed is:

1. A composition for coating an electrical contact point comprising a silver powder and a fluorinated resin,
wherein the silver powder is dispersed in the fluorinated resin, and
a weight ratio of the silver powder to the fluorinated resin is in a range from 0.4 to 1.

2. The composition of claim 1, wherein:
a diameter of the silver powder is in a range from 3 to 50 μm.

3. The composition of claim 2, wherein:
the fluorinated resin includes polytetrafluoroethylene (PTFE), tetrafluoroethylene-perfluoroalkyl vinyl ether copolymer (PFA), tetrafluoroethylene hexafluoropropylene copolymer (FEP), ethylene tetrafluoroethylene (ETFE), polychlorotrifluoroethylene (PCTFE), ethylene chlorotrifluoroethylene (ECTFE), polyvinylidene fluoride (PVDF), polyvinyl fluoride (PVF), or combinations thereof.

4. A method for coating an electrical contact point, the method comprising steps of:
preparing a contact point base material;
preparing a composition for coating the electrical contact point;
coating the composition for coating the electrical contact point on the contact point base material; and
hardening the coated composition to form a coating layer on a surface of the contact point base material.

5. The method of claim 4, wherein:
in the step of preparing the composition for coating the electrical contact point,
the composition for coating the electrical contact point includes a silver powder and a fluorinated resin,
the silver powder is dispersed in the fluorinated resin,
a weight ratio of the silver powder to the fluorinated resin is in a range from 0.4 to 1.

6. The method of claim 5, wherein:
a diameter of the silver powder is in a range from 3 to 50 μm.

7. The method of claim 6, wherein:
the fluorinated resin includes polytetrafluoroethylene (PTFE), tetrafluoroethylene-perfluoroalkyl vinyl ether copolymer (PFA), tetrafluoroethylene hexafluoropropylene copolymer (FEP), ethylene tetrafluoroethylene (ETFE), polychlorotrifluoroethylene (PCTFE), ethylene chlorotrifluoroethylene (ECTFE), polyvinylidene fluoride (PVDF), polyvinyl fluoride (PVF), or combinations thereof.

8. The method of claim 4, wherein:
in the step of preparing the contact point base material,
the contact point base material is a copper or a copper alloy.

9. The method of claim 4, wherein:
in the step of coating the composition for coating the contact point on the contact point base material,
a roll coating method, a spray method, or a dipping method is performed.

10. The method of claim 4, wherein:
the step of forming the coating layer on the surface of the contact point base material by hardening the coated composition is performed in a temperature range from 150 to 250° C.

11. The method of claim 10, wherein:
the step of forming the coating layer on the surface of the contact point base material by hardening the coated composition is performed for 10 to 60 minutes.

12. The method of claim 11, wherein:
in the step of hardening the coated composition, a thickness of the coating layer is in a range from 3 to 100 μm.
